(19) United States
(12) Patent Application Publication
(10) Pub. No.: US 2008/0285004 A1
(43) Pub. Date: Nov. 20, 2008

(54) Monolithic, Non-Contact Six Degree-of-Freedom Stage Apparatus

(75) Inventors: Michael B. Binnard, Belmont, CA (US); Yoichi Arai, Saitama-ken (JP); Douglas C. Watson, Campbell, CA (US); Alton H. Phillips, East Palo Alto, CA (US)

Correspondence Address: AKA CHAN LLP, 900 LAFAYETTE STREET, SUITE 710, SANTA CLARA, CA, 95050, US

(73) Assignee: NIKON CORPORATION, Tokyo (JP)

(21) Appl. No.: 11/750,545

(22) Filed: May 18, 2007

(51) Int. Cl. G03B 27/58; G03B 27/62

(52) U.S. Cl. 355/72; 355/75

(57) ABSTRACT

Methods and apparatus for controlling a stage assembly in up to six degrees of freedom using actuators which each allow for forces to be generated in a horizontal direction and a vertical direction are disclosed. According to one aspect of the present invention, a stage apparatus includes a stage assembly and a first stator arrangement. The stage assembly includes a first magnet arrangement of an actuator assembly, and the first stator arrangement is part of the actuator assembly. The first magnet arrangement cooperates with the first stator arrangement to allow the stage assembly to move relative to a first horizontal axis as well as a vertical axis.

### BACKGROUND OF THE INVENTION

1. Field of Invention

The present invention relates generally to lithographic systems. More particularly, the present invention relates to a stage apparatus which is monolithic and is capable of movement in up to six degrees of freedom.

2. Description of the Related Art

For many machines or instruments such as photolithography machines which are used in semiconductor processing, space is often at a premium. The lack of available space often forces components to be sized as compactly as possible. As a result, restricting the size of components of a stage apparatus allows the space in an overall machine to be efficiently utilized. By way of example, the size of a component that is arranged to provide a particular force or motion allows the space in an overall machine to be efficiently utilized.

Many machines include linear motors which may be used to provide a force that is used to drive an object or a structure, e.g., a stage of a photolithography machine. Since linear motors typically effectively only produce a non-zero net force in a single direction, a linear motor may generally only be used to apply force on an object, as for example a stage assembly, in a single direction such as a y-direction. In order for the object to be moved more than one direction, e.g., both a y-direction and a z-direction, an additional linear motor which is arranged to apply a force substantially only in z-direction generally must also be coupled to object. While the use of a pair of linear motors may be effective in allowing an object to move in both a y-direction and a z-direction, the use of more than one linear motor on a stage assembly may not always be possible due to space constraints within an overall system. Further, the use of an additional linear motor may cause issues associated with the addition of mass to the overall system, and the generation of heat within the overall system. As will be appreciated by those skilled in the art, additional mass may cause vibrations within the overall system, while additional heat may adversely affect the performance of various components, e.g., sensors, within the overall system.

A planar motor, i.e., a motor with a substantially flat plate of magnets and coils, is arranged to provide force in an x-direction and a y-direction. Hence, a single planar motor may be used in lieu of two linear motors to provide a non-zero net force in an x-direction and a y-direction. However, a planar motor is generally more complicated to control than a linear motor. Further, since many systems are arranged to use linear motors, the use of a planar motor instead of one or more linear motors may be impractical.

The ability for stage devices, e.g., reticle stages, to move in a z-direction is often critical to ensure the accurate positioning of the stage devices during a photolithography process. However, in many systems, adding the capability for a stage device to move in a z-direction is often either impractical or not feasible due to space constraints and other issues related to adding an additional actuator that facilitates movement in the z-direction.

Non-contact stage devices are preferably such that there are no wires or hoses connected to moving portions of the stage devices. Hence, enabling a non-contact stage device to move in a z-direction, in addition to an x-direction and a y-direction, may be further complicated by the requirement that the non-contact stage device has no mechanical contact with any other structure.

Therefore, what is desired is a non-contact stage device which translates in at least a y-direction, and a z-direction. That is, what is needed is a method and an apparatus which allows a monolithic stage device to translate in at least a y-direction and a z-direction with substantially no mechanical contact with any other structure.

### BRIEF SUMMARY OF THE INVENTION

The present invention relates to utilizing actuators which each allow for forces to be generated in a horizontal direction and a vertical direction to control the positioning of a monolithic stage device. According to one aspect of the present invention, a stage apparatus includes a stage assembly and a first stator arrangement. The stage assembly includes a first magnet arrangement of an actuator assembly, and the first stator arrangement is part of the actuator assembly. The first magnet arrangement cooperates with the first stator arrangement to allow the stage assembly to move relative to a first horizontal axis as well as a vertical axis.

In one embodiment, the first stator arrangement includes a coil assembly positioned at least partially within the first magnet arrangement and has a first coil and a second split coil. In another embodiment, the stage apparatus also includes a base arrangement and an anti-gravity device that support a weight of the stage assembly relative to the vertical axis.

Including an actuator that provides a non-zero net force along a horizontal axis and a vertical axis in an overall stage apparatus that includes a stage with a monolithic structure enhances the capabilities of such a stage. The stage is controllable in both a horizontal direction and a vertical direction without requiring an actuator that allows for control in the horizontal direction and another actuator that allows for control in the vertical direction. Hence, the capability to control the stage in the horizontal direction and the vertical direction is provided substantially without requiring additional space for an additional actuator, and also substantially without increasing heat generation and vibrations within the overall stage apparatus.

According to another aspect of the present invention, a method for controlling a stage which is a part of a stage apparatus that has a first actuator arrangement with a first magnet arrangement and a first stator arrangement, a second actuator arrangement, and a countermass arrangement includes applying at least one current to the first stator arrangement. Applying the current to the first stator arrangement causes the stage to move in at least one of a first horizontal direction and a vertical direction. The method also includes actuating the second actuator arrangement to cause the stage to move in a second horizontal direction. The first stator arrangement and the second stator arrangement are included in the countermass arrangement.

In one embodiment, the countermass arrangement includes a frame that defines an operating area of the stage. In another embodiment, the first actuator arrangement includes four linear motors. Each linear motor of the four linear motors is positioned at corners of the stage, and produces a force in the first horizontal direction and a force in the vertical direction using magnets of the first magnet arrangement and stators of the first stator arrangement.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1A is a top view block diagram representation of a stage apparatus which utilizes three split coil linear motors in accordance with an embodiment of the present invention.

FIG. 1B is a top-view block diagram representation of a stage apparatus which utilizes four split coil linear motors in accordance with an embodiment of the present invention.

FIG. 2 is a diagrammatic side-view representation of an actuator with a split coil in accordance with an embodiment of the present invention.

FIG. 3A is a diagrammatic top-view representation of a monolithic reticle stage apparatus in accordance with an embodiment of the present invention.

FIG. 3B is a diagrammatic perspective representation of a monolithic reticle stage apparatus, i.e., monolithic reticle stage apparatus 330 of FIG. 3A, in accordance with an embodiment of the present invention.

FIG. 3C is a diagrammatic perspective representation of a monolithic reticle stage, i.e., monolithic reticle stage 340 of FIG. 3A, in accordance with an embodiment of the present invention.

FIG. 4A is a block diagram representation of a stage that is supported by an air bearing arrangement in accordance with an embodiment of the present invention.

FIG. 4B is a block diagram representation of a stage that is supported by an air bearing arrangement that includes a soft spring in accordance with an embodiment of the present invention.

FIG. 4C is a block diagram representation of a stage that is supported on an air bearing arrangement that includes a carrier stage and an anti-gravity piston in accordance with an embodiment of the present invention.

FIG. 5 is a diagrammatic representation of a photolithography apparatus in accordance with an embodiment of the present invention.

FIG. 6 is a process flow diagram which illustrates the steps associated with fabricating a semiconductor device in accordance with an embodiment of the present invention.

FIG. 7 is a process flow diagram which illustrates the steps associated with processing a wafer, i.e., step 1304 of FIG. 6, in accordance with an embodiment of the present invention.

FIG. 8 is a diagrammatic representation of a monolithic reticle stage assembly that uses two carrier stage components to support a reticle stage in accordance with an embodiment of the present invention.

FIG. 9 is a diagrammatic exploded representation of a monolithic reticle stage assembly that includes two carrier stages in accordance with an embodiment of the present invention.

FIG. 10 is a diagrammatic representation of a carrier stage arrangement that includes two carrier stages that each carry a gravity canceller in accordance with an embodiment of the present invention.

FIG. 11A is a diagrammatic representation of a portion of a carrier stage arrangement with two carrier stages with gravity cancellers, e.g., carrier stages 630 of FIG. 10, in accordance with an embodiment of the present invention.

FIG. 11B is a diagrammatic representation of a carrier stage with a gravity canceller, e.g., carrier stage 630 of FIG. 11A, in accordance with an embodiment of the present invention.

FIG. 12A is a diagrammatic representation of a carrier stage arrangement that includes two carrier stages with gravity cancellers and has an associated carrier stage countermass in accordance with an embodiment of the present invention.

FIG. 12B is a diagrammatic cross-sectional side-view representation of a carrier stage arrangement that has an associated carrier stage countermass, e.g., carrier stage arrangement 730 of FIG. 12A, in accordance with an embodiment of the present invention.

FIG. 13 is a diagrammatic representation of a reticle stage drive section, e.g., reticle stage drive section 640 of FIG. 9, in accordance with an embodiment of the present invention.

FIG. 14 is a diagrammatic representation of a reticle stage, e.g., reticle stage 650 of FIG. 9, in accordance with an embodiment of the present invention.

FIG. 15A is a block diagram representation of a double reticle fine stage that is supported on an air bearing arrangement that includes a carrier stage in accordance with an embodiment of the present invention.

FIG. 15A is a block diagram representation of a plurality of reticle stages that are each supported on air bearing arrangements that include carrier stages in accordance with an embodiment of the present invention.

FIG. 16A is a diagrammatic top-view representation of a monolithic reticle stage apparatus that includes a single reticle stage that carries a plurality of reticles in accordance with an embodiment of the present invention.

FIG. 16B is a diagrammatic top-view representation of a monolithic reticle stage apparatus that includes a plurality of reticle stages in accordance with an embodiment of the present invention.

FIG. 17 is a top-view block diagram representation of a stage apparatus which utilizes long stator voice coil motors in accordance with an embodiment of the present invention.

FIG. 18 is a diagrammatic exploded representation of monolithic reticle stage assembly that utilizes long stator voice coil motors in accordance with an embodiment of the present invention.

### DETAILED DESCRIPTION OF THE INVENTION

When a stage such as a reticle stage has the capability to move up and down, i.e., along a z-axis, the accuracy with which a reticle may be positioned is enhanced. In many stage systems, however, providing the capability for a stage to move in a z-direction is often difficult due to space constraints and other issues related to the addition of an additional actuator that facilitates movement in the z-direction. For example, in addition to taking up physical space within an overall stage apparatus, the addition of an actuator that is dedicated to allowing a stage to move along a z-axis may cause issues relating to excessive heat generation and excessive vibratory motion.

Configuring an actuator such as a linear motor to provide a non-zero net force along two axes, e.g., a y-axis and a z-axis allows forces to be applied along both axes substantially without requiring the use of an additional linear motor or voice coil motor. As a result, no space is needed within an overall system to accommodate an additional linear motor. In one embodiment, by utilizing a split coil, e.g., a plurality of coils, within the linear motor, the current applied to top and bottom halves of the split coil may be controlled such that forces along both a y-axis and a z-axis may be controlled. The current may be a multiphase current. Split coil linear motors which provide forces in two directions including a z-direction are described in co-pending U.S. patent application Ser. No. 10/935,995, filed Sep. 8, 2004, which is incorporated herein by reference in its entirety.

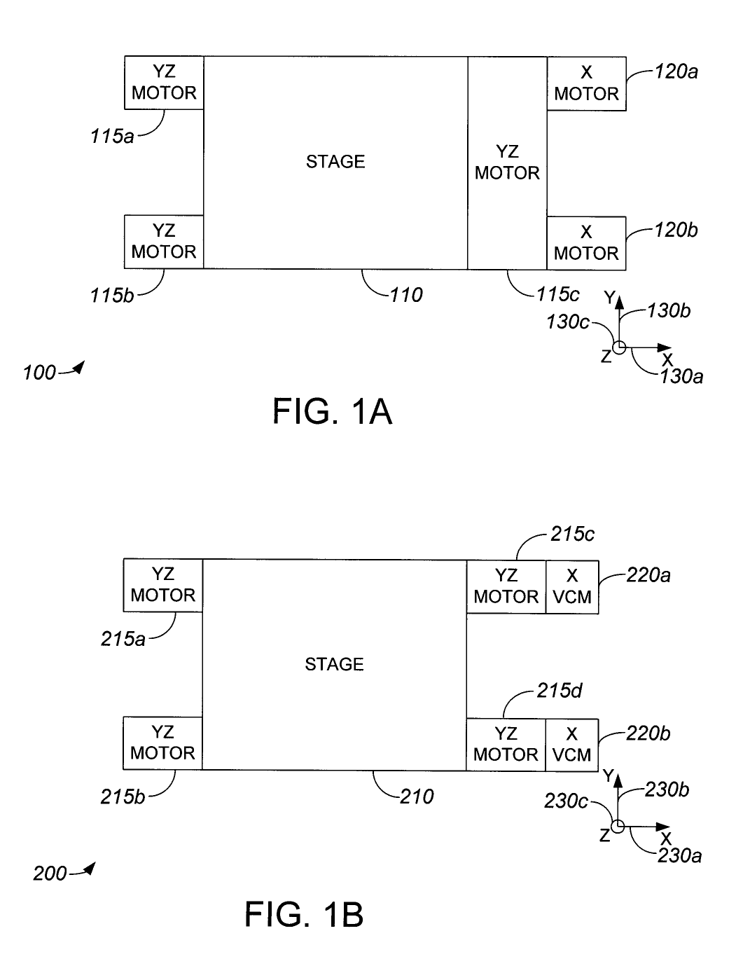

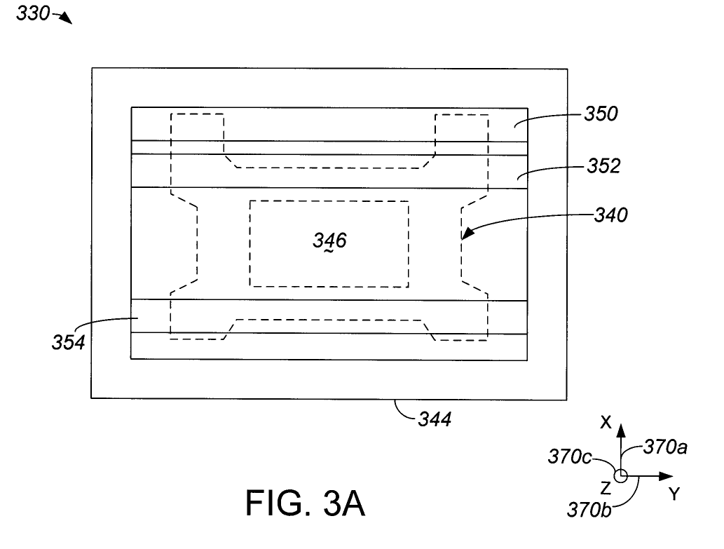

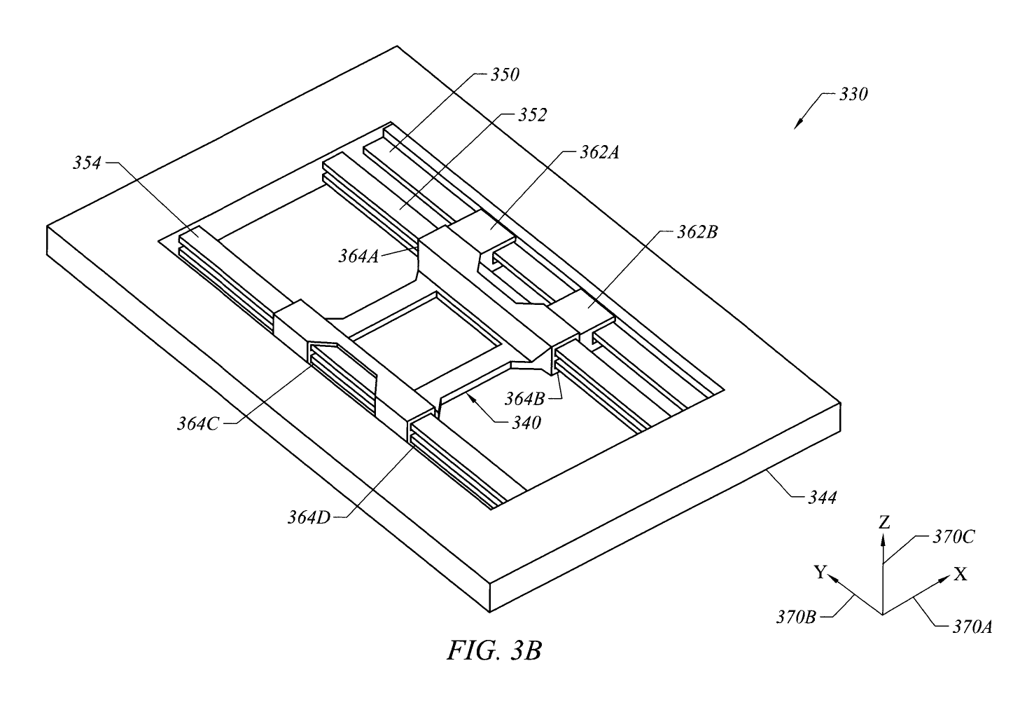

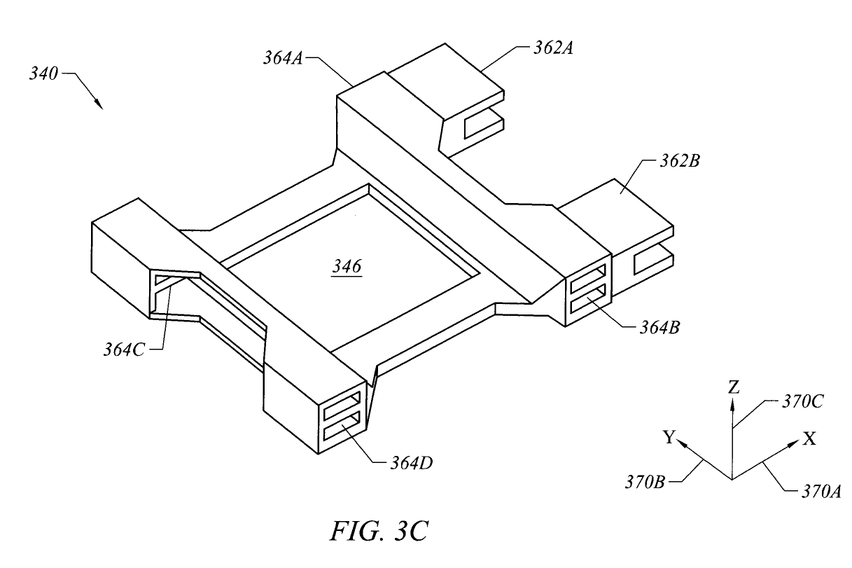

Including an actuator that provides a non-zero net force along a y-axis and a z-axis in an overall stage apparatus that includes a stage with a monolithic structure enhances the capabilities of such a stage. FIG. 1A is a top-view block diagram representation of a stage apparatus which utilizes a plurality of split coil linear motors or, more generally, linear motors which are each capable of providing movement along a y-axis and along a z-axis, to facilitate the movement of a stage along a y-axis and a z-axis in accordance with a first embodiment of the present invention. A stage apparatus 100 includes a stage 110, e.g., a reticle stage, that is arranged to translate relative to an x-axis 130a, a y-axis 130b, and a z-axis 130c. Stage 110 may be a monolithic stage that is coupled to a countermass (not shown) that substantially surrounds a working area of stage 110, as will be discussed below with reference to FIGS. 3A-C.

Stage 110 is effectively coupled to parts of motors 120a, 120b which are arranged to provide forces which allow stage 110 to translate or be driven relative to x-axis 130a. In one embodiment, motors 120a, 120b may be voice coil motors, although it should be appreciated that motors 120a, 120b may generally be any suitable type of actuators. The magnets associated with motors 120a, 120b may be coupled to stage 110 while the coils of motors 120a, 120b may be coupled to a countermass (not shown). As will be appreciated by those skilled in the art, the magnets associated with motors 120a, 120b are generally not mechanically coupled or in physical contact with the coils of motors 120a, 120b. Although two motors 120a, 120b are shown, a single motor may instead be used to allow stage 110 to translate relative to x-axis 130a.

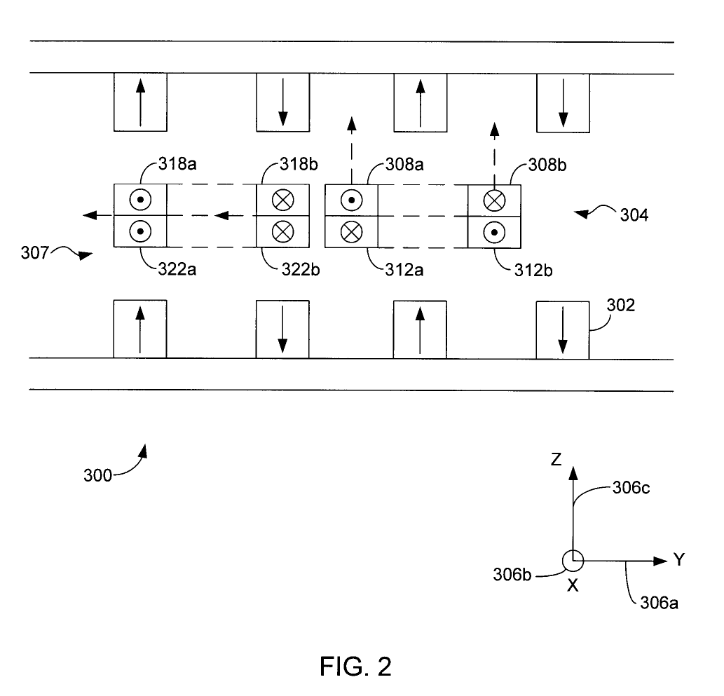

Three motors 115a-c are arranged to drive stage 110 along y-axis 130b and z-axis 130c. Motors 115a-c may utilize split coils to enable non-zero forces to be generated along y-axis 130b and z-axis 130c. That is, motors 115a-c may include split coils that allow each motor 115a-c to generate a force in a direction along y-axis 130b and a force in a direction along z-axis 130c. One suitable split coil motor will be described below with respect to FIG. 2. As shown, motors 115a, 115b are positioned substantially at corners of stage 110. Motor magnets associated with motors 115a-c are generally coupled to stage 110, while the stators associated with motors 115a-c are coupled to a countermass (not shown) such that the magnets of the motors are not in mechanical contact with the stators.

Stage 110 may have up to six degrees of freedom. By way of example, in addition to being driven in translational degrees of freedom along x-axis 130a, y-axis 130b, and z-axis 130c, stage 110 may also rotate about x-axis 130a, y-axis 130b, and z-axis 130c. As will be appreciated by those skilled in the art, differentially actuating or driving motors 115a-c and differentially actuating or driving motors 120a, 120b controls rotational motion, i.e., roll, pitch, and yaw.

In general, the number of motors which provide forces along a y-axis and a z-axis may vary widely. For example, three motors such as motors 115a-c of FIG. 1A may provide forces along a y-axis and a z-axis. Alternatively, as shown in FIG. 1B, four motors may be used to provide forces and, hence, translation along a y-axis and a z-axis. A stage apparatus 200 includes a stage 210 which is arranged such that four motors 215a-d which provide movement relative to both a y-axis 230b and a z-axis 230c are coupled to the corners of stage 210. Motors 215a-d generally include split coils that enable motors 215a-d to provide forces that drives stage 210 along both y-axis 230b and z-axis 230c. Stage 210 is further coupled to motors 220a, 220b which provide a force that drives stage 210 along an x-axis 230a.

With reference to FIG. 2, a motor with a split coil that may be used as a motor such as motor 115a of FIG. 1A or motor 215a of FIG. 1B will be described in accordance with an embodiment of the present invention. A motor 300 includes magnets 302, a split coil 304 that is made up of a top half 308 and a bottom half 312, and a split coil 307 that is made up of a top half 318 and a bottom half 322. Typically, split 304 and split coil 307 are part of an array of similar coils that extends in a y-direction 306a. Split coils 304, 307 are generally arranged relative to magnets 302 substantially within a space defined between at least some of magnets 302. In one embodiment, split coils 304, 307 are arranged as part of a countermass (not shown) in an overall stage apparatus. Motor 300 may be substantially any motor which uses a coil arrangement, e.g., motor 300 may be a linear motor or a voice coil motor. In the described embodiment, motor 300 is a linear motor. The current provided to top half 308 and the current provided to top half 318 may each be multiphase, and may be controlled substantially independently from the current provided to bottom half 312 and bottom half 322, respectively.

Split coil 304 may be arranged such that portions of top half 308a, 308b may have current flowing in an opposite direction along an x-axis 306b than portions of bottom half 312a, 312b, respectively, to provide a substantially non-zero net force along a z-axis 306c. Specifically, current may flow in portion 308a in an opposite direction along x-axis 306b than in portion 312a, and current may flow in portion 308b in an opposite direction along x-axis 306b than in portion 312b. When current in half 308 flows in an opposite direction along x-axis 306b from current in half 312, forces along y-axis 306a are effectively cancelled out. In other words, when current flows in half 308 in an opposite direction along x-axis 306b as current in half 312, the net force generated along y-axis 306a by split coil 304 is effectively zero when the currents have substantially the same magnitude, while the net force generated along z-axis 306c is non-zero. Hence, as shown, split coil 304 is arranged to provide a non-zero net force in a direction along z-axis 306c when currents of equal magnitude and opposite directions are applied to halves 308, 312. Reversing the direction in which current is applied to both top half 308 and bottom half 312 provides net force in the opposite direction along z-axis 306c.

While split coil 304 is arranged to provide non-zero net forces along z-axis 306c, in the embodiment as shown, split coil 307 is arranged to provide non-zero net forces along a y-axis 306a. Split coil 307 is arranged such that portions of top half 318a, 318b may have current flowing in the same direction along x-axis 306b as portions of bottom half 322a, 322b, respectively, to provide force along y-axis 306a. When approximately equal current flows in the same direction in top half 318 and bottom half 322, the net force along z-axis 306c is substantially zero, while there is a non-zero net force along y-axis 306a.

By allowing the current that flows through top half 308 and bottom half 312 of split coil 304 to flow in opposite directions along x-axis 306b and by allowing the current that flows through top half 318 and bottom half 322 of split coil 307 to flow in the same direction along x-axis 306b, split coil 304 effectively enables motor 300 to generate a non-zero net force with respect to z-axis 306c while split coil 307 effectively enables motor 300 to generate a non-zero net force with respect to y-axis 306a. As a result, motor 300 is capable of being used to provide non-zero net forces in both a direction along y-axis 306a and a direction along z-axis 306c such that a stage assembly coupled to magnets 302 may translate along y-axis 306a and along z-axis 306c. Separate current sources are generally needed for the top half and the bottom half of a split coil, e.g., top half 308 and bottom half 312 of split coil 304. As a motor moves, the directions in which current is applied to the split coil may vary due to commutation.

As mentioned above, magnets, e.g., magnets 302 of FIG. 2, may generally be coupled to a stage while split coils, e.g., split coils 304, 307 of FIG. 2, are generally coupled to a structure such as a countermass. The split coils may be arranged to move with respect to the magnets substantially within a field generated by the magnets. The countermass is generally arranged to absorb at least some of the reaction forces generated by movement of the stage. Referring next to FIGS. 3A-C, a stage assembly which includes a monolithic stage and a frame countermass, and utilizes a motor which provides forces in both a y-direction and a z-direction will be described in accordance with an embodiment of the present invention. FIG. 3A is a diagrammatic top-view representation of a monolithic reticle stage apparatus in accordance with an embodiment of the present invention. A reticle stage apparatus 330 includes a reticle stage 340 and a countermass 344 that is arranged around reticle stage 340. Reticle stage 340 is lightweight and monolithic, and includes a reticle window 346. Substantially no wires or hoses are connected to reticle stage 340. It should be appreciated that though stage 330 is described as a reticle stage, stage 330 may be substantially any stage, as for example a wafer stage.

In the described embodiment, countermass 344 is arranged as a substantially rectangular frame that surrounds the operating area of reticle stage 340. That is, any translation along an x-axis 370a and a y-axis 370b of reticle stage 340 occurs within an area defined within countermass 344. It should be appreciated, however, that the configuration of countermass 344 may vary. In general, countermass 344 may have up to three degrees of freedom. In some embodiments, countermass 344 may have six degrees of freedom.

Countermass 344 is arranged to support stator arrangements 350, 352, 354. Stator arrangements are 350, 352, 354 are arranged to cooperate with magnet arrangements 362a, 362b and magnet arrangements 364a-d, as shown in FIGS. 3B and 3C, to operate as motors. Stator arrangement 350 and magnet arrangements 362a, 362b cooperate to operate as motors that drive reticle stage 340 along x-axis 370a. Stator arrangement 352 and magnet arrangements 364a, 364b, which may include two or four units of motor magnets, cooperate to function as motors, e.g., linear motors or moving magnet motors, that allow reticle stage 340 to be driven and controlled along y-axis 370b and along a z-axis 370c. Similarly, stator arrangement 354 and magnet arrangements 364b, 364c, which may include two or four units of motor magnets, also cooperate to function as motors that allow reticle stage 340 to be driven and controlled along y-axis 370b and along z-axis 370c. In the embodiment as shown, stator arrangement 354 and magnet arrangements 364b, 364c effectively form two pairs of motors where the motors of each pair are vertically separated relative to z-axis 370c, while stator arrangement 352 and magnet arrangements 364a, 364b effectively form two pairs of motors where the motors of each pair are also vertically separated relative to z-axis 370c. It should be appreciated, however, that rather than including eight motors which each allow reticle stage 340 to be controlled along both y-axis 370b and z-axis 370, the number of such motors may vary. By way of example, one such motor essentially at each corner of reticle stage 340 may be used to control reticle stage 340 along both y-axis 370b and z-axis 370. As previously mentioned, the motors may also be driven differentially to control rotation of reticle stage 340 about x-axis 370a, y-axis 370b, and z-axis 370c. Hence, reticle stage 340 has up to six degrees of freedom.

Stator arrangements 352, 354 are generally split coils, and the split coils typically have current that is independently controlled. That is, split coils associated with stator arrangements 352, 354 are such that each coil has a current supply that may be independently controlled. The use of split coils, as well as the placement of magnet arrangements 364a-d substantially at the corners of reticle stage 340, allows relatively high acceleration relative to y-axis 370b, and also enables rotation about x-axis 370a and y-axis 370b, as well as displacement along z-axis 370c, to be relatively accurately controlled.

Magnets 364a-d and stator arrangements 352, 354 may provide sufficient power to allow the weight of reticle stage 340 to be supported relative to z-axis 370c. Typically, if acceleration along y-axis 370b is sufficiently high, substantially any amount of heat generated by the motors that include magnets 364a-d and stator arrangements 352, 354 to support the weight of reticle stage 340 may be relatively insignificant. However, if providing sufficient power to allow the weight of reticle stage 340 to be supported by motors that include magnets 364a-d and stator arrangements 352, 354 causes significant heat to be generated or causes significant force disturbances in reticle stage apparatus 330, an antigravity device may be used to substantially support the weight of reticle stage 340.

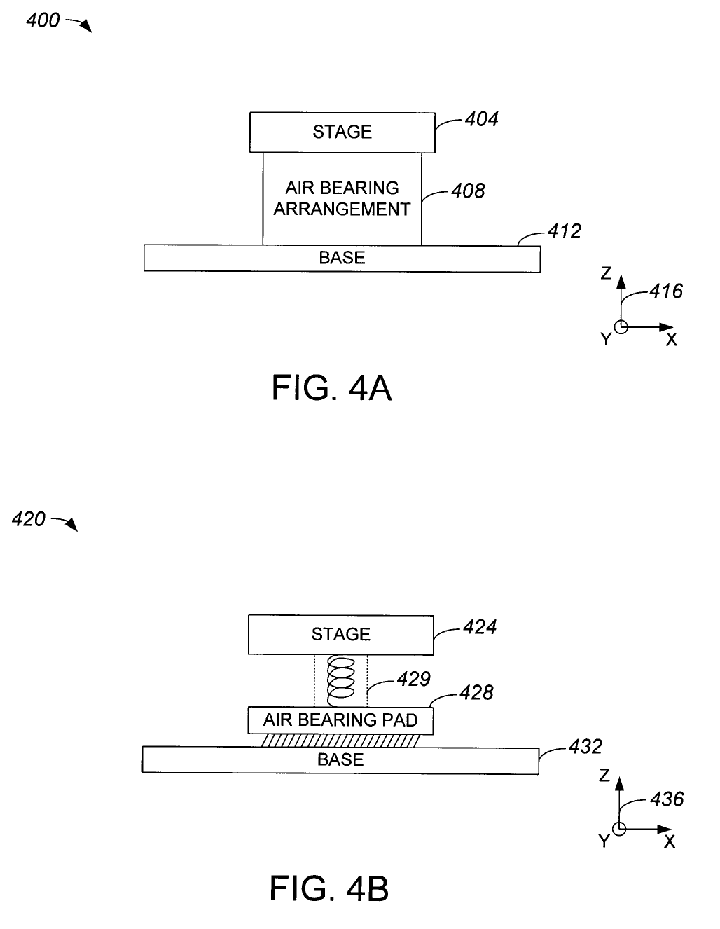

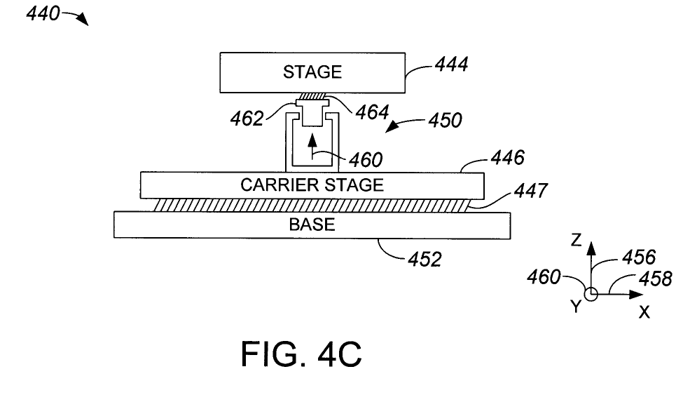

In general, an air bearing arrangement may be incorporated into an antigravity device that supports the weight of a reticle stage such as reticle stage 340. FIG. 4A is a block diagram representation of a stage that is supported by an air bearing arrangement in accordance with an embodiment of the present invention. A stage arrangement or assembly 400 includes a stage 404. Stage 404, which may be a lightweight, monolithic reticle stage such as reticle stage 340 of FIGS. 3A-C that is not connected to any hoses or cables, is supported over a base 412 by an air bearing arrangement 408. Air bearing arrangement 408 is arranged to support stage 404 relative to a z-axis 416 such that stage 404 is effectively movably held over base 412. In other words, air bearing arrangement 408 supports stage 404 such that stage 404 may translate over base 412 substantially without coming into contact with base 412.

Air bearing arrangement 408 may have a variety of different configurations. With reference to FIG. 4B, one suitable configuration for an air bearing arrangement will be described in accordance with an embodiment of the present invention. A stage arrangement or assembly 420 includes a monolithic reticle stage 424 that has up to six degrees of freedom. An air bearing pad 428 and a soft spring 429 are arranged to support stage 424 over a base 432. An air supply (not shown) may supply air through openings in base 432 such that air bearing pad 428 moves over base 432 on a cushion of air 430. Air bearing pad 428 cooperates with cushion of air 430 to form an air bearing arrangement.

Soft spring 429 may generally be a flexure, a mechanical spring, an air bellows, or an air piston that allows stage 424 to move with air bearing pad 428. Soft spring 429 provides antigravity support for stage 424, i.e., soft spring 429 supports the weight of stage 424 relative to a z-axis 436 substantially without constraining vertical motion of stage 424.

An air bearing arrangement such as air bearing arrangement 408 of FIG. 4A may also be configured to include a carrier stage. FIG. 4C is a diagrammatic representation of a stage assembly which is supported by an air bearing arrangement that includes a carrier stage in accordance with an embodiment of the present invention. A stage assembly 440 includes a stage 444 that is effectively supported over a base 452. An antigravity device 450 is positioned on a carrier stage 446, and provides support for carrier stage 446 relative to a z-axis 456. Carrier stage 446 has an air bearing surface that moves over a cushion of air 447 that is positioned between carrier stage 446 and base 452. In one embodiment, air is supplied through base 452 to form cushion of air 447. Carrier stage 446 may be coupled to actuators (not shown) which allow carrier stage 446 to move relative to at least one of an x-axis 458 and a y-axis 460.

Antigravity device 450 may have a variety of different configurations. As shown, antigravity device 450 is a piston arrangement which includes a piston head 462. When a pressure 460 is applied to piston head 462, a vertical force is created on piston head 462 which supports the weight of stage 444. An air bearing 464 is positioned between piston head 462 and stage 444. Air bearing 464 generally includes a bearing surface and an air cushion. Piston head 462 and air bearing 464 cooperate to enable stage 444 to be supported over base 452, while enabling stage 444 to translate and to rotate.

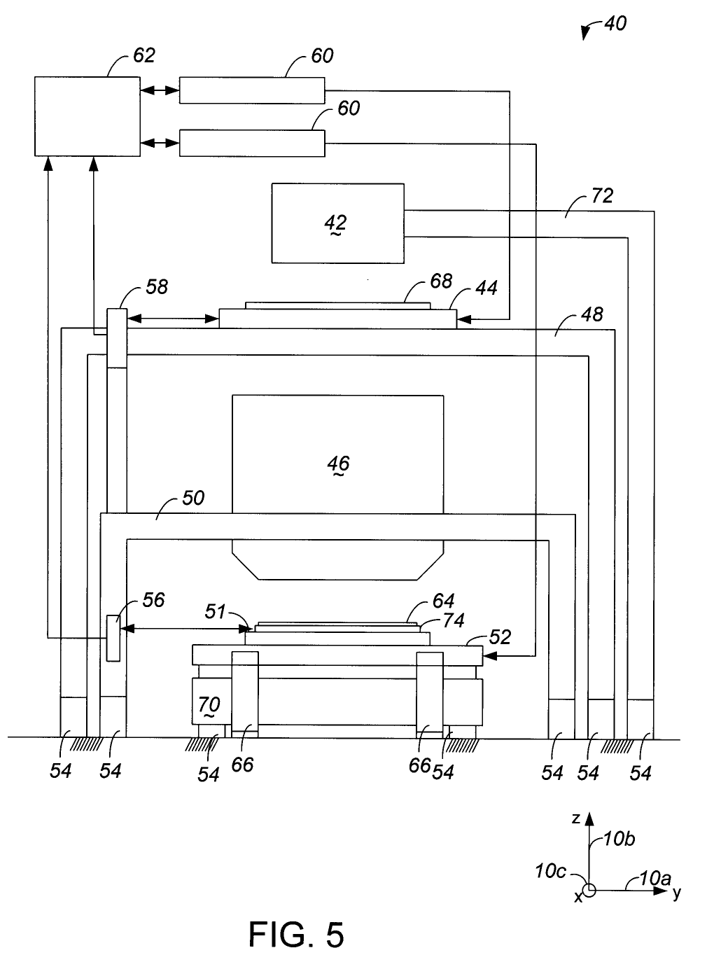

A monolithic stage device which has up to six degrees of freedom may generally be used as a part of an overall photolithography apparatus. Referring next to FIG. 5, a photolithography apparatus which may utilize a monolithic stage that uses a split coil motor to allow for motion along both a y-axis and a z-axis will be described in accordance with an embodiment of the present invention. A photolithography apparatus (exposure apparatus) 40 includes a wafer positioning stage 52 that may be driven by linear or planar motors (not shown), as well as a wafer table 51 that is magnetically coupled to wafer positioning stage 52. The motor which drives or motors which drive wafer positioning stage 52 generally utilize an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between two to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of VCMs (not shown), e.g., three voice coil motors. The motor arrangement of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties. Alternatively, a wafer stage system may also use a countermass to absorb reaction forces.

An illumination system 42 is supported by a frame 72. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which may be a monolithic reticle stage with up to six degrees of freedom. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. patents are incorporated herein by reference in their entireties. A multiple stage exposure apparatus is also described in Japan patent Application Disclosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and a EUVL type exposure apparatus when suitable measures are incorporated to accommodate the vacuum environment for air (fluid) bearing arrangements.

Further, in photolithography systems, when linear motors (see U.S. Pat. No. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

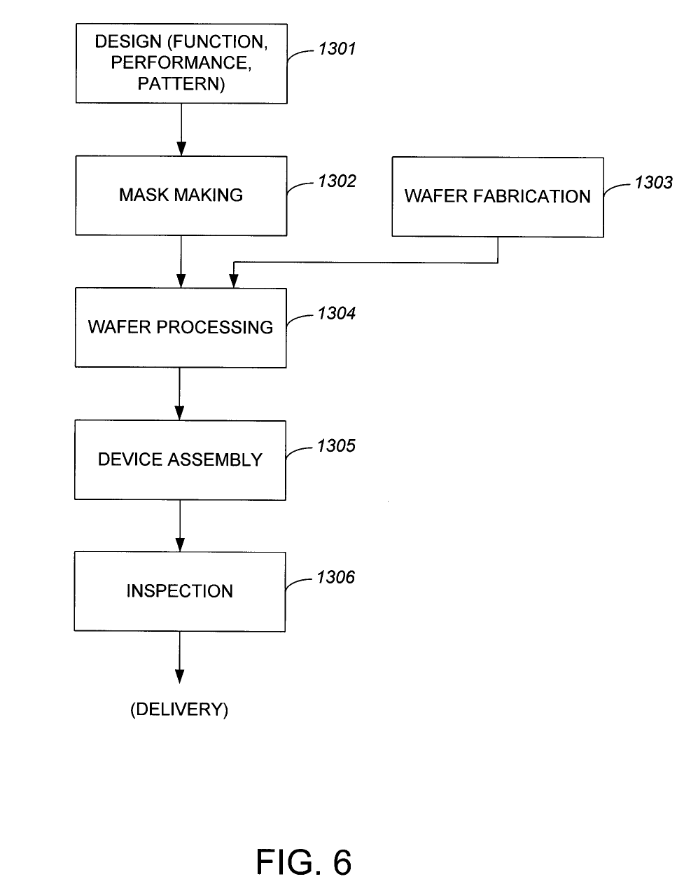

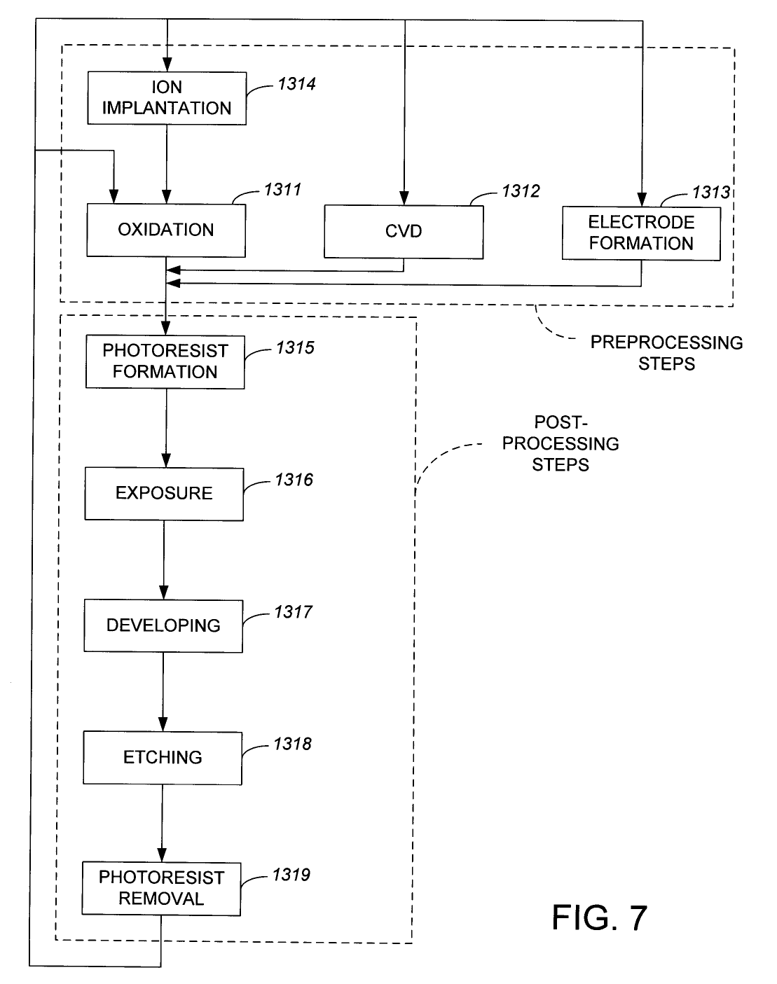

Further, semiconductor devices may be fabricated using systems described above, as will be discussed with reference to FIG. 6. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 7. In step 1305, the semiconductor device is assembled. The assembly of the semiconductor device generally includes, but is not limited to, wafer dicing processes, bonding processes, and packaging processes. Finally, the completed device is inspected in step 1306.

FIG. 7 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage. It should be appreciated that when the circuit pattern of the reticle is transferred to the wafer, an automatic reticle blind is generally in an open position to allow a laser beam to pass therethrough.

After the circuit pattern on a reticle is transferred to a wafer, the exposed wafer is developed in step 1317. Once the exposed wafer is developed, parts other than residual photoresist, e.g., the exposed material surface, may be removed by etching in step 1318. Finally, in step 1319, any unnecessary photoresist that remains after etching may be removed. As will be appreciated by those skilled in the art, multiple circuit patterns may be formed through the repetition of the preprocessing and post-processing steps.

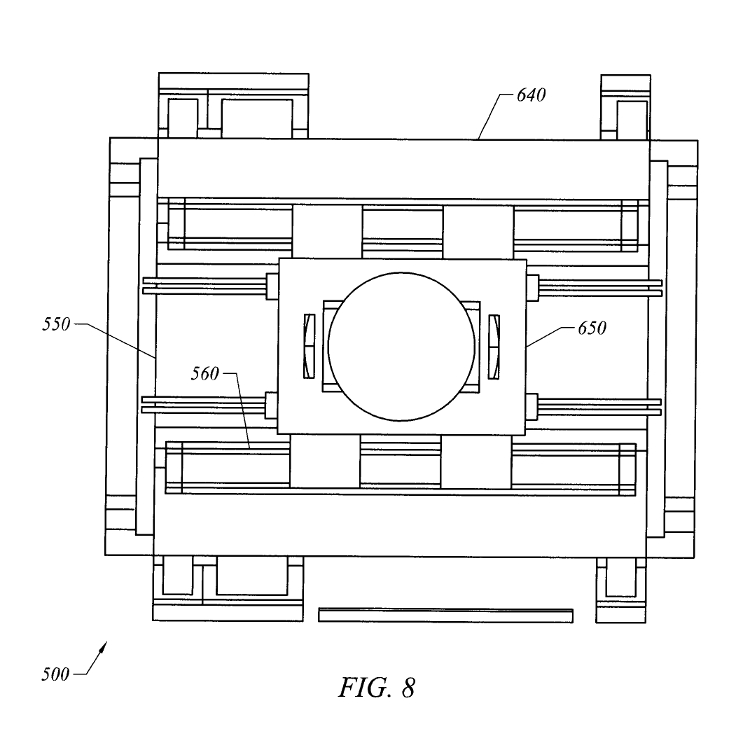

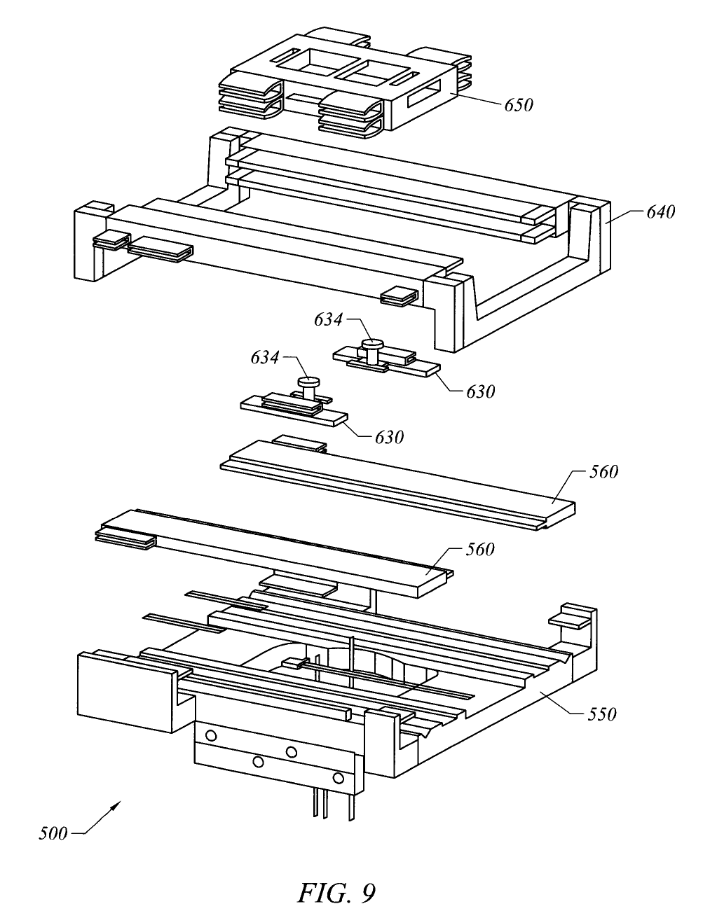

The design of a monolithic reticle stage assembly which includes an actuator that provides a non-zero net force along a y-axis and a z-axis may vary widely. By way of example, a carrier stage that supports a reticle fine stage may effectively be two separate, but cooperating, stages that each include a gravity cancelling component. The use of a carrier stage that effectively has two halves minimizes the size if the carrier stage, and reduces the amount of mass that moves. In addition, such a carrier stage provides more of an opening or space through which light may shine through a reticle. FIG. 8 is a diagrammatic top-view representation of a monolithic reticle stage assembly that uses two carrier stage components to support a reticle stage, and FIG. 9 is an exploded representation of the monolithic reticle stage assembly of FIG. 8 in accordance with an embodiment of the present invention. It should be understood that some components of reticle stage 500 that are visible in FIG. 9 are not visible in FIG. 8. A stage assembly 500 includes a reticle stage 650. Although reticle stage 650 is described, it should be understood that stage assembly 500 may instead include a wafer stage. Reticle stage 650 cooperates with a reticle stage drive unit 640 which, in one embodiment, may be a countermass. Reticle stage assembly 500 may be provided with voice coil motors and linear motors that provide up to six degrees of freedom to reticle stage 650, while reticle stage drive unit 640 has approximately three degrees of freedom.

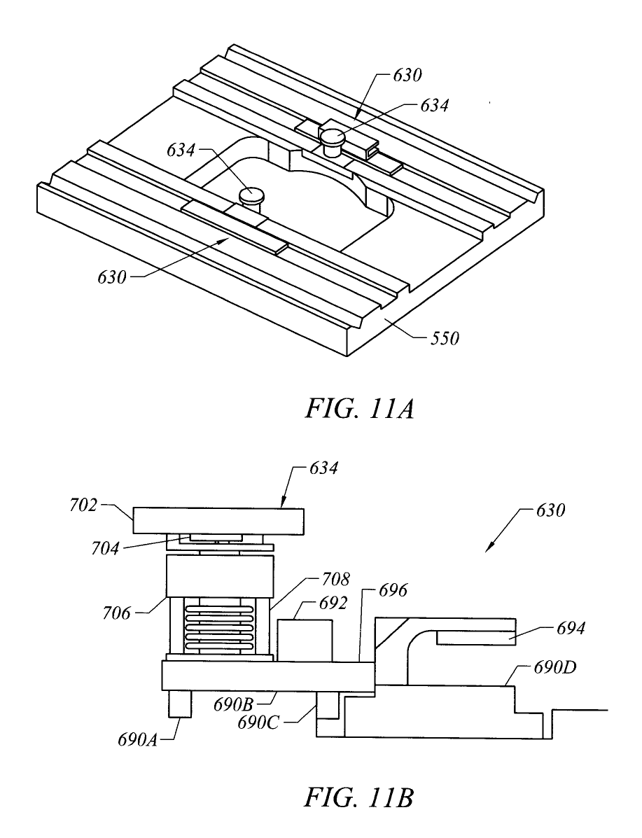

A carrier stage 630 which, as shown, may effectively include two separate components, is arranged to support reticle stage 650. Carrier stage 630 may include gravity cancellers 634 with bellows and air bearings to support the weight of reticle stage 650. Gravity cancellers 634 will be discussed below with reference to FIGS. 11A and 11B. A carrier stage drive unit 560 has one degree of freedom, and may be trimmed with one or more linear motors. Carrier stage 630 is generally arranged to allow reticle stage 650 to move over a base 550. In the described embodiment, neither reticle stage 650 nor carrier stage 560 are attached to cables or hoses.

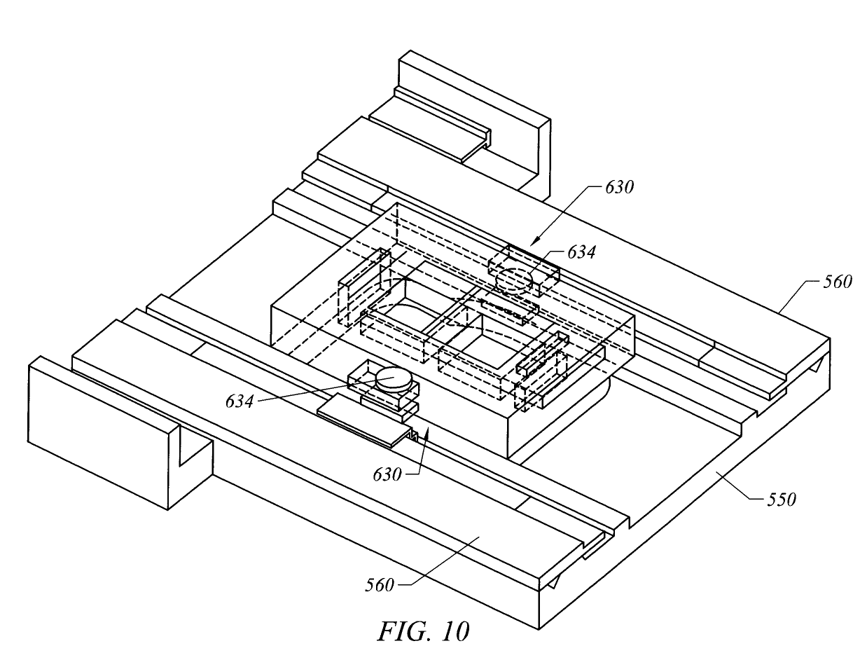

As previously mentioned, reticle stage 630 may be supported by a two-component carrier stage 630 that includes gravity cancellers 634. FIG. 10 is a diagrammatic representation of reticle stage 650 being supported over base 550 by carrier stage halves 630 with gravity cancellers 634. With reference to FIGS. 11A and 11B, a half of carrier stage 630 will be described in accordance with an embodiment of the present invention. Carrier stage 630 is positioned such that carrier stage 630 moves over base 550 on a plurality of air bearing arrangements 690a-d. Air bearing arrangements 690a-c may have air supplied thereto by a regulator 692 which, in one embodiment, may include an air tank. Air bearing arrangement 690d may include a ground supply (not shown) that provides air and/or vacuum that enables carrier stage 630 to move over base 550. A flexure 696 allows for some flexibility in carrier stage 630. Carrier stage 630 also includes a drive motor magnet 694 that cooperates with a carrier stage drive unit (not shown) to drive carrier stage 630 in one horizontal degree of freedom. Specifically, drive motor magnet 694 may cooperate with a drive motor coil (not shown) that is coupled to a carrier stage drive unit.

A gravity canceller 634 may generally be any device that provides anti-gravity support to a reticle stage carried by carrier stage 630. In the described embodiment, gravity canceller 634 includes an air bearing 702, a tilting flexure 704, an air bushing 706, and a bellows 708. Bellows 708 generally moves up and down to allow z-motion of carrier stage 630, while tilting flexure 740 allows for rotational motion about x and y axes of a reticle stage (not shown) that may be supported over air bearing 702. Although bellows 708 is shown, other devices such as springs or pistons may be included in gravity canceller 634 in lieu of bellows 708. Pressurized air in bellows 708 provides a z force to substantially counteract gravity acting on carrier stage 630.

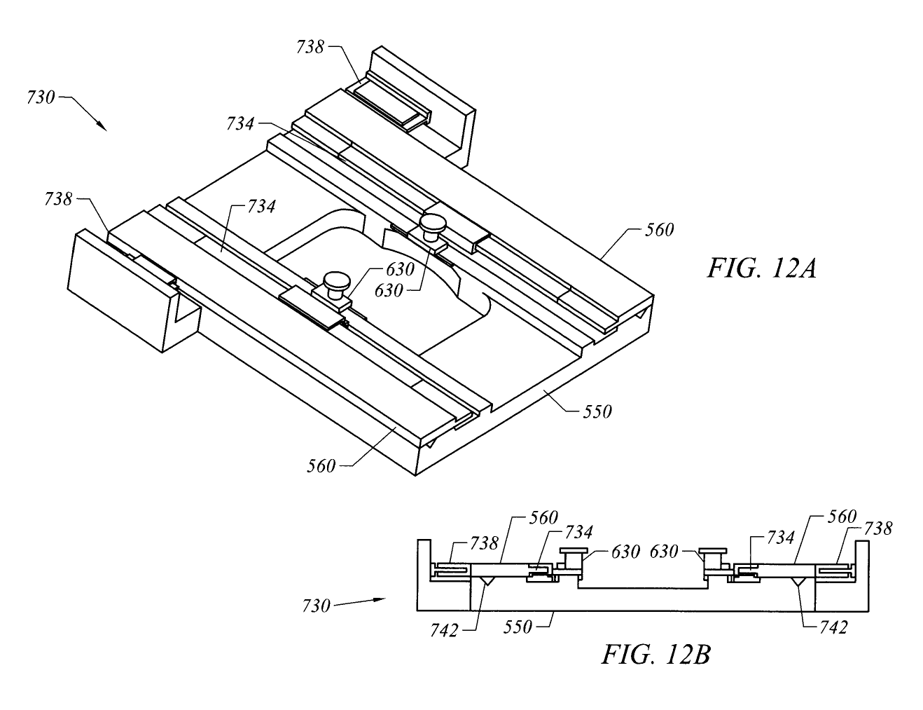

Carrier stage 630 may be associated with a countermass that includes a carrier stage drive unit, e.g., carrier stage drive unit 560 of FIG. 9, Referring next to FIGS. 12A and 12B, an overall carrier stage counter mass assembly will be described in accordance with an embodiment of the present invention. A carrier stage counter mass assembly 730 includes carrier stage drive unit 560 and a carrier stage drive coil arrangement 734. Trim motors 738 may couple carrier stage drive unit 560 to base 550. In one embodiment, a yaw guide 742 effectively constrains carrier stage drive unit 560 to move in substantially only one degree of freedom.

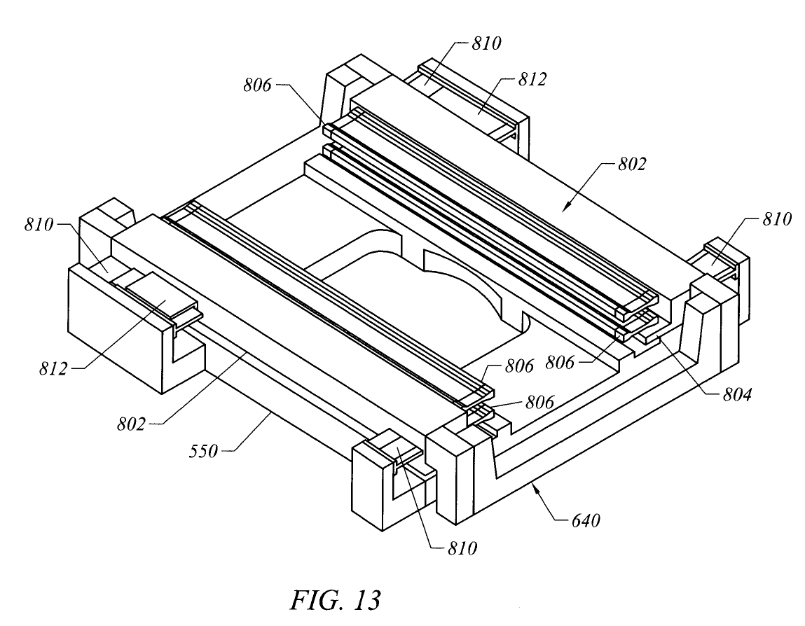

A reticle stage supported on a carrier stage may be driven using a reticle stage drive unit. With reference to FIG. 13, a reticle stage drive unit, e.g., reticle stage drive unit 640 of FIG. 9, will be described in accordance with an embodiment of the present invention. A reticle stage drive unit 640 may generally include a counter mass arrangement 802 and motors that provide up to six degrees of freedom. At least one voice coil motor 804 is arranged to drive a reticle stage (not shown) relative to a first horizontal axis such as an x-axis, while at least one motor 806 that has two degrees of freedom are arranged to drive the reticle stage (not shown) relative to a second horizontal axis such as a y-axis and relative to a vertical axis. In the described embodiment, four motors 806 that each have two degrees of freedom cooperate to provide rotational motion, in addition to translational motion relative to the second horizontal axis and a vertical axis.

Reticle stage drive unit 640 may be coupled to base 550 via trim motors 810, 812. Trim motors 810 provide trim relative to the first horizontal axis, as for example an x-axis, and also provide trim relative to rotation about a vertical axis. Trim motors 810 may be voice coil motors. Trim relative to a second horizontal axis, as for example a y-axis, is provided by trim motors 812 that may be linear motors.

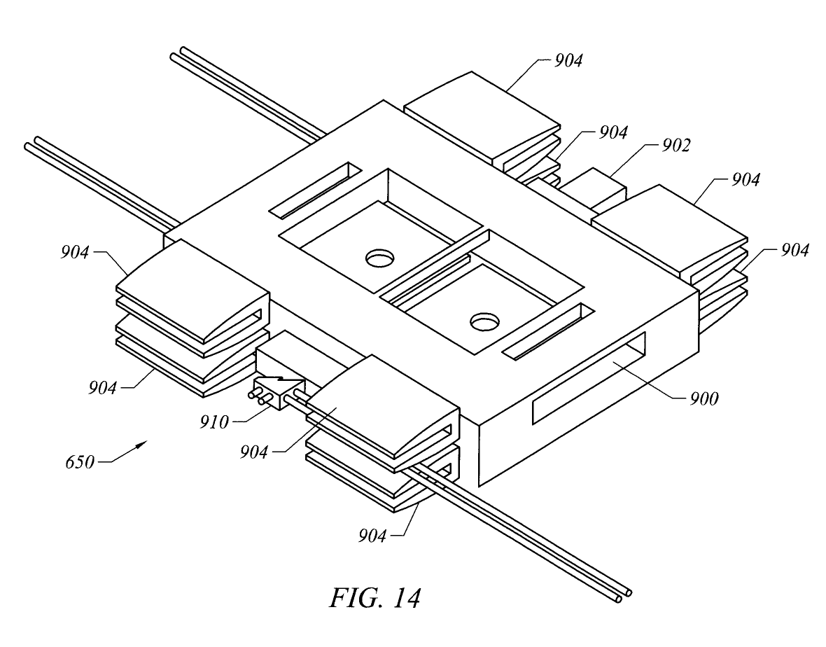

One embodiment of a reticle stage such as reticle stage 650 of FIG. 9 will be described with respect to FIG. 14. A reticle stage 650 is arranged to accept a reticle through a slot 900. A magnet 902 is a part of a voice coil motor that provides translational motion to reticle stage 650 along a horizontal axis. Magnets 904 are arranged as components of motors that provide two degrees of freedom, one along a horizontal axis and another along a vertical axis. In the described embodiment, eight magnets 904 are shown, although it should be appreciated that the number of magnets 904 may vary. An interferometer 910, which is arranged to measure translation along the horizontal axis associated with magnet 902, may provide a beam through a slot (not shown) in a reticle stage drive unit such that measurements relating to reticle stage 650 may be made.

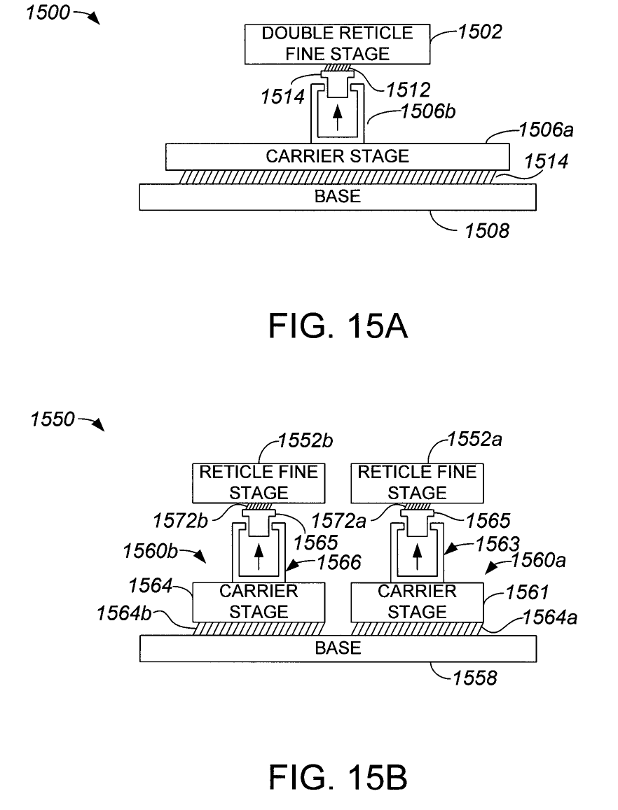

The ability for a monolithic stage device to be used to provide double exposure may increase the throughput associated with the monolithic stage device. In one embodiment, to provide an increased throughput, a reticle stage that is supported by an antigravity device may be a reticle stage that holds a plurality of reticles. That is, a lightweight, monolithic reticle stage may be a double reticle stage. FIG. 15A is a block diagram representation of a double reticle stage that is supported by an air bearing arrangement in accordance with an embodiment of the present invention. A stage assembly 1500 includes a double reticle fine stage 1502 that is supported by an air bearing arrangement 1506a, 1506b. In the described embodiment, the air bearing arrangement includes a carrier stage 1506a and an antigravity device 1506b. Carrier stage 1506a is arranged to move over a cushion of air 1514 that is formed using air supplied through a base 1508. Antigravity device 1506b is shown as being a piston arrangement with an air bearing 1512 between a piston head 1514 and double reticle fine stage 1502. Air bearing 1512 includes a bearing surface and an air cushion that cooperate with air bearing 1512 to allow double reticle fine stage 1502 to be supported over base 1508. Although antigravity device 1506b is shown as including a piston arrangement, antigravity device 1506b may generally have a variety of different configurations.

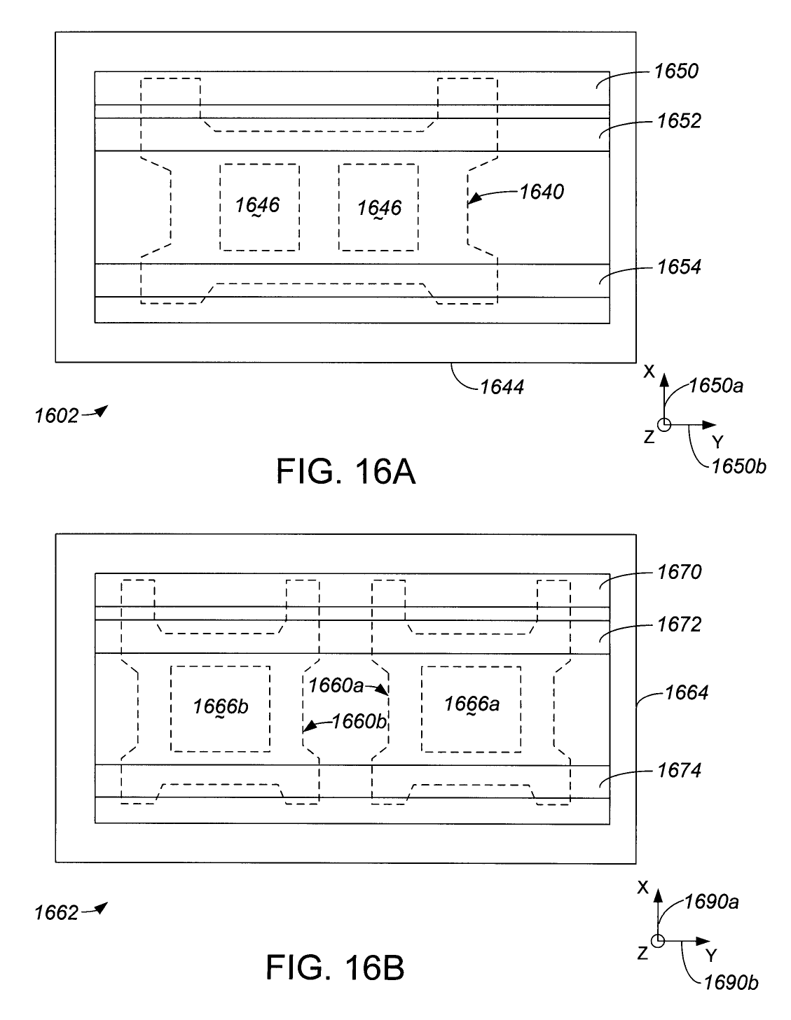

FIG. 16A is a diagrammatic top-view representation of a double reticle fine stage apparatus in accordance with an embodiment of the present invention. A double reticle stage apparatus 1602 includes a double reticle stage 1640 and a countermass 1644 that is arranged around double reticle stage 1640. Reticle stage 1640 is lightweight, monolithic, and includes substantially no wires or hoses. As shown, reticle stage 1640 includes a plurality of reticle windows 1646. It should be understood that double reticle stage 1640 may include more than two reticle windows 1646, and may be substantially any stage, as for example a wafer stage.

Countermass 1644 may be arranged as a substantially rectangular frame that surrounds the operating area of double reticle stage 1640 such that any translation along an x-axis 1650a and a y-axis 1650b of double reticle stage 1640 occurs within an area defined within countermass 1644. It should be appreciated, however, that the configuration of countermass 1644 may vary. In general, countermass 1644 may have up to three degrees of freedom, and may be arranged to support stator arrangements 1650, 1652, 1654.

While a double reticle fine stage such as double reticle stage 1640 is effective in increasing the throughput associated with a system that includes double reticle stage 1640, double reticle stage 1640 is generally larger than a reticle stage that supports only one reticle. Hence, actuators used to drive double reticle stage 1640 generally generate higher forces and, therefore cause a degradation in a performance level, e.g., due to additional generated heat and the amount of power needed to generate the higher forces.

To maintain approximately the same dynamic performance as a stage apparatus which uses a single reticle while still allowing for more than one reticle to be used within a system, a plurality of reticle stages may be included in an overall stage apparatus. In such a system, each of the reticle stages may have its own associated actuators and sensors. FIG. 15B is a block diagram representation of a plurality of reticle stages that are each supported by a separate air bearing arrangement in accordance with an embodiment of the present invention. A stage assembly 1550 includes a plurality of reticle fine stages 1552a, 1552b that are supported by air bearing arrangements 1560a, 1560b, respectively. In the described embodiment, air bearing arrangement 1560a includes a carrier stage 1561 and an antigravity device 1560a, while air bearing arrangement 1560b includes a carrier stage 1564 and an antigravity device 1560b. Each carrier stage 1561, 1564 is arranged to move over a cushion of air 1564a, 1564b, respectively, that is formed using air supplied through a base 1558. Antigravity devices 1563, 1566 are shown as being piston arrangement with air bearings 1572a, 1572b between piston heads 1562, 1565 and their respective reticle stages 1552a, 1552b. It should be understood that antigravity devices 1563, 1566 may be devices other than piston arrangements. Air bearings 1572a, 1572b each include a bearing surface and an air cushion that cooperate with air bearings 1572a, 1572b to support reticle stages 1552a, 1552b, respectively, over base 1508.

FIG. 16B is a diagrammatic top-view representation of a plurality of reticle fine stages of an apparatus in accordance with an embodiment of the present invention. An apparatus 1652 includes reticle stages 1660a, 1660b, and a countermass 1664 that is arranged around and shared by reticle stages 1660a, 1660b. Though two reticle stages 1660-a, 1660b, it should be appreciated that any number of reticle stages may generally be included in apparatus 1652. In one embodiment, reticle stages 1660a, 1660b are lightweight, monolithic, and include substantially no wires or hoses. Each reticle stage 1660a, 1660b includes a reticle window 1666a, 1666b, respectively.

Countermass 1664 may be arranged as a substantially rectangular frame that surrounds the operating area of reticle stages 1660a, 1660b such that any translation along an x-axis 1690a and a y-axis 1690b of reticle stages 1660a, 1660b occurs within an area defined within countermass 1664. Countermass 1644 may have up to three degrees of freedom, and may be arranged to support stator arrangements 1670, 1672, 1674. As shown, stator arrangements 1670, 1672, 1674 are shared by reticle stages 1660a, 1660b. However, in some instances, each reticle stage 1660a, 1660b may have its own stator arrangements. Further, each reticle stage 1660a, 1660b may have its own associated countermass.

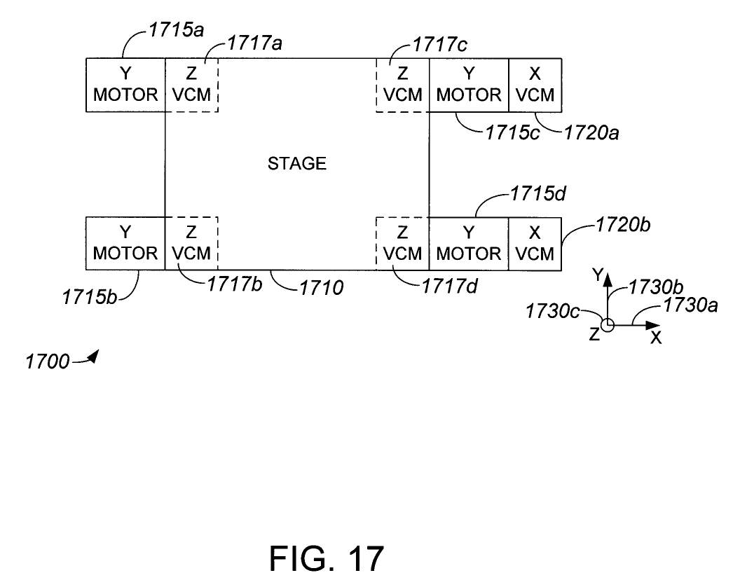

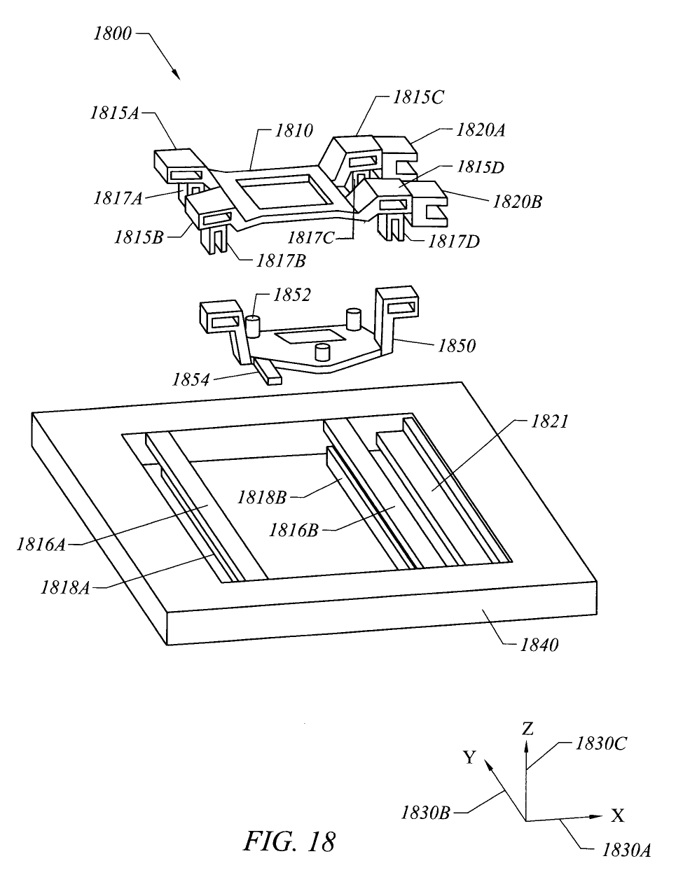

The actuators used to drive a monolithic stage assembly may vary widely. By way of example, in lieu of using linear motors with two degrees of freedom to drive a stage assembly, separate voice coil motors may be used to provide movement in each of the two degrees of freedom. The use of separate motors may reduce disturbances that may be associated with an actuator having two degrees of freedom during an exposure process. In particular, voice coil motors with long stators that provide translational movement relative to an x-axis and a z-axis may be used in conjunction with 3-phase motors that provide movement relative to a y-axis. FIG. 17 is a top-view block diagram representation of a stage apparatus which utilizes long stator voice coil motors to provide translation along an x-axis and a z-axis in accordance with an embodiment of the present invention. A stage apparatus 1700 includes a stage 1710, e.g., a reticle fine stage or a dual reticle fine stage, that is arranged to translate relative to an x-axis 1730a, a y-axis 1730b, and a z-axis 1730c. In one embodiment, stage 1710 may be a lightweight, monolithic stage that is not coupled to hoses or wires. Further, stage 1710 may be coupled to a countermass (not shown) that substantially surrounds a working area of stage 1710. Countermass will be described below with reference to FIG. 18.

Stage 1710 is effectively coupled to parts of motors 1720a, 1720b which are arranged to provide forces which allow stage 1710 to translate or be driven relative to x-axis 1730a. Motors 1720a, 1720b may be long stator voice coil motors that allow for relatively long travel relative to y-axis 1730b. It should be appreciated that magnets, as for example a magnet array, associated with motors 1720a, 1720b may be approximately “U” shaped to allow for relatively rigid coil support. Such magnets may be coupled to stage 1710 while the coils of motors 1720a, 1720b may be coupled to a countermass (not shown). As will be appreciated by those skilled in the art, the magnets associated with motors 1720a, 1720b are generally not mechanically coupled or in physical contact with the coils of motors 1720a, 1720b. While two motors 1720a, 1720b are shown, a single long stator motor may instead be used to allow stage 1710 to translate relative to x-axis 1730a.

Long stator voice coil motors 1717a-d are arranged to drive stage 1710 along z-axis 1730c. Although four voice coil motors 1717a-d are shown, the number of voice coil motors 1717a-d that drive stage 1710 along z-axis 1730c may vary. By way of example, three long stator voice coil motors may be used to drive stage 1710 along z-axis 1730. Long stator voice coil motors 1717a-d, which may include “U” shaped magnets (not shown) that allow rigid support for coils (not shown), are positioned at corners of stage 1710. In one embodiment, long stator voice coil motors 1717a-d may be positioned substantially directly under motors 1715a-d, respectively. Motor magnets associated with voice coil motors 1717a-d are generally coupled to stage 1710, while the stators associated with motors 1717a-d are coupled to a countermass (not shown) such that the magnets of the motors are not in mechanical contact with the stators. Motors 1715a-d, which are three-phase linear motors in one embodiment, are arranged to drive stage 1710 along y-axis 1730b. In general, at least two motors 1715a-d are used to drive stage 1710 along y-axis 1730b, although four motors 1715a-d are shown.

Stage 1710 may have up to six degrees of freedom. In addition to translational degrees of freedom along x-axis 1730a, y-axis 1730b, and z-axis 1730c, stage 1710 may also rotate about x-axis 1730a, y-axis 1730b, and z-axis 1730c. Differentially actuating or driving motors 1720a, 1720b, 1715a-d, and 1717a-d controls rotational motion, i.e., roll, pitch, and yaw.

FIG. 18 is a diagrammatic exploded representation of monolithic reticle stage assembly that utilizes long stator voice coil motors in accordance with an embodiment of the present invention. A stage assembly 1800 includes a stage 1810 that is carried on a carrier stage 1850 that includes at least one of a bellows 1852 and an air bearing 1854 that support stage 1810. Bellows 1852 is an anti-gravity device that supports stage 1810 against gravity, although it should be appreciated that substantially any anti-gravity device may be implemented in lieu of bellows 1852. Carrier stage 1850 has, in the described embodiment, one degree of freedom, and is arranged to move relative to a y-axis 1830b over an air-bearing surface between carrier stage 1850 and a base surface (not shown). A ground-supply for air and vacuum (not shown) is provided to carrier stage 1850. Carrier stage 1850 is driven by linear motors which may share the same stators 1816 as stage 1810.

Stage 1810 is coupled to y-motor components 1815a-d that are arranged to cooperate with components 1816a, 1816b to drive stage 1810 along y-axis 1830b. x-motors include x-motor components 1820a, 1820b that are coupled to stage 1810 and cooperate with stator 1821 to drive stage 1810 along an x-axis 1830a. Finally, z-motors, include components 1817a-d that are coupled to stage 1810, and cooperate with stators 1818a, 1818b to drive stage 1810 along a z-axis 1830c. Specifically, components 1817a, 1817b cooperate with stator 1818a, while components 1817c, 1817d cooperate with stator 1818b.

Stators 1816a, 1816b and stators 1818a, 1818b, 1821 are effectively part of a countermass 1840 which, in the described embodiment, is a frame that absorbs at least some of the reaction forces generated when stage 1810 moves. Countermass 1840 is arranged to substantially surround an operating area of stage 1810.

In general, stage 1810 may support a single object such as a reticle. It should be appreciated, however, that as described above with respect to FIGS. 15A and 15B, stage assembly 1800 may be arranged to include a stage that holds more than one reticle, or to include more than one carrier stage 1850 and/or more than one stage 1810.

Although only a few embodiments of the present invention have been described, it should be understood that the present invention may be embodied in many other specific forms without departing from the spirit or the scope of the present invention. By way of example, while split coil motors have generally been described as enabling a stage to move relative to a y-axis and a z-axis, split coil motors may instead be arranged to allow a stage to move relative to an x-axis and a z-axis. In an embodiment in which split coil motors allows for movement relative to an x-axis and a z-axis, separate motors may be used to provide movement relative to a y-axis.

While the use of three or four motors which provide movement relative to both a y-axis and a z-axis is effective, the number of motors which provide movement relative to both a y-axis and a z-axis may generally vary widely. For instance, in an embodiment in which the force requirement relative to a y-axis is relatively high, up to eight motors which provide movement relative to both the y-axis and a z-axis may be used to drive the stage along the y-axis.

In one embodiment, magnet arrangements that cooperate with stators to form actuators or motors that drive a stage may be considered to be part of an overall stage arrangement. For example, magnet arrangements 362a, 362b and magnet arrangements 364a-d, together with reticle stage 340, may be considered to form a reticle stage arrangement. Such a reticle stage arrangement typically does not have mechanical or physical contact with any other structure. Additionally, when a stage is coupled to a soft spring arrangement and an air bearing pad, the soft spring arrangement and the air bearing pad may be considered to be part of an overall stage arrangement.

An actuator used to provide movement along one horizontal axis, i.e., an x-axis or a y-axis, and a vertical axis, i.e., a z-axis, may vary. In other words, an actuator other than a split coil linear motor may be used to allow a stage to be controlled relative to both a horizontal axis and a vertical axis without departing from the spirit or the scope of the present invention.

An anti-gravity device may be arranged to provide actuation in a vertical direction. That is, in one embodiment, an anti-gravity device may be arranged to include an actuator that allows a stage to move along a z-axis. Such an actuator may augment the actuation provided by an actuator that allows the stage to be controlled relative to both a horizontal direction and the vertical direction.

Stators associated with motors which allow a stage to be driven and controlled may generally be considered to be part of a countermass frame. That is, a countermass may include the mass associated with motor stators. As previously mentioned, a countermass may have a variety of different configurations. Therefore, the present examples are to be considered as illustrative and not restrictive, and the invention is not to be limited to the details given herein, but may be modified within the scope of the appended claims.

The invention claimed is:

1. A stage apparatus comprising:
a stage assembly, the stage assembly including a first magnet arrangement; and
a countermass, the countermass being arranged to include a first stator arrangement, wherein the first stator arrangement is arranged to cooperate with the first magnet arrangement to allow the stage assembly to move relative to a first horizontal axis and a vertical axis, and wherein the countermass is arranged to absorb reaction forces associated with the stage assembly.

2. The stage apparatus of claim 1 further including:
a countermass, the countermass being arranged to include the first stator arrangement, wherein the countermass is arranged to absorb reaction forces associated with the stage assembly

3. The stage apparatus of claim 1 wherein the first stator arrangement includes a coil assembly, the coil assembly being arranged to cooperate with the first magnet arrangement, the coil assembly including a top half and a bottom half, the top half and the bottom half being arranged to be substantially independently controlled such that a multiphase first current applied to the top half may be applied substantially independently from a multiphase second current applied to the bottom half.

4. The stage apparatus of claim 3 wherein the multiphase first current and the multiphase second current interact with the first magnet arrangement to independently control a net force applied to the stage assembly along the first horizontal axis and a net force applied to the stage assembly along the vertical axis.

5. The stage apparatus of claim 1 wherein the stage assembly further includes a second magnet arrangement and the stage apparatus further includes a second stator arrangement, wherein the second magnet arrangement and the second stator arrangement are arranged to cooperate to allow the stage assembly to be controlled relative to a second horizontal axis, the second horizontal axis being substantially perpendicular to the first horizontal axis.

6. The stage apparatus of claim 5 wherein the stage assembly is arranged to rotate relative to the first horizontal axis, the second horizontal axis, and the vertical axis.

7. The stage apparatus of claim 1 wherein the first magnet arrangement and the first stator arrangement are arranged to cooperate to allow the stage assembly to rotate.

8. The stage apparatus of claim 1 wherein the stage assembly is a monolithic stage assembly.

9. The stage apparatus of claim 1 wherein the stage assembly is a non-contact stage.

10. The stage apparatus of claim 1 further including:
a base arrangement; and
an anti-gravity device, the anti-gravity device being arranged to support a weight of the stage assembly relative to the vertical axis, wherein the anti-gravity device is positioned substantially over the base arrangement.

11. The stage apparatus of claim 10 wherein the anti-gravity device includes a carrier stage arrangement and a piston arrangement, the carrier stage arrangement being arranged to translate over the base arrangement on a first air bearing, the piston arrangement being arranged to apply a force that supports the stage assembly on a second air bearing.

12. The stage apparatus of claim 10 wherein the anti-gravity device includes an air bearing arrangement and a soft spring arrangement, the soft spring arrangement being substantially positioned between the stage assembly and the air bearing arrangement.

13. The stage apparatus of claim 12 wherein the soft spring arrangement is one selected from the group including a flexure, a mechanical spring, an air bellows, and an air piston.

14. The stage apparatus of claim 10 wherein the anti-gravity device includes a carrier stage arrangement and a bellows arrangement.

15. The stage apparatus of claim 12 wherein the carrier stage arrangement includes first and second stage components, the first stage component being arranged to translate over the base arrangement on a first air bearing and the second stage component being arranged to translate over the base arrangement on a second air bearing, the anti-gravity device including a first soft spring supported on the first stage component and arranged to apply a first force that supports the stage assembly, the anti-gravity device further including a second soft spring supported on the second stage component and arranged to apply a second force that supports the stage assembly.

16. The stage apparatus of claim 1 wherein the stage assembly includes a first stage and a second stage, the stage apparatus further including:
a base arrangement;
a first antigravity device, the first anti-gravity device being arranged to support a weight of the first stage relative to the vertical axis, wherein the first anti-gravity device is positioned substantially over the base arrangement; and
a second antigravity device, the second antigravity device being arranged to support a weight of the second stage relative to the vertical axis, wherein the second anti-gravity device is positioned substantially over the base arrangement.

17. The stage apparatus of claim 1 wherein the stage assembly is arranged to support a plurality of reticles.

18. The stage apparatus of claim 1 wherein the first magnet arrangement and the first stator arrangement are associated with a plurality of linear motors, the plurality of linear motors each being arranged to cause the stage assembly to move relative to the first horizontal axis and the vertical axis.

19. The stage apparatus of claim 1 wherein the stage apparatus is part of an illumination system of an exposure apparatus.

20. A device manufactured with the exposure apparatus of claim 19.

21. A wafer on which an image has been formed by the exposure apparatus of claim 19.

22. A method for controlling a stage, the stage being a part of a stage apparatus that also includes a first actuator arrangement, and a second actuator arrangement, the first actuator arrangement including a first magnet arrangement coupled to the stage and a first stator arrangement, the first actuator arrangement being arranged to cause the stage to move in a first horizontal direction and a vertical direction, the second actuator arrangement including a second magnet arrangement coupled to the stage and a second stator arrangement, the second actuator arrangement being arranged to control motion of the stage to move in a second horizontal direction, the method comprising:
applying at least one current to the first stator arrangement, wherein applying the at least one current to the first stator arrangement produces force on the stage in at least one of the first horizontal direction and the vertical direction; and
actuating the second actuator arrangement, wherein actuating the second actuator arrangement produces force on the stage in the second horizontal direction.

23. The method of claim 21 wherein the first stator arrangement and the second stator arrangement are part of a counter mass arrangement, the countermass arrangement including a frame, the frame being arranged to define a space, the space encompassing an operating area of the stage.

24. The method of claim 21 wherein the first stator arrangement includes a coil assembly having a first coil and a second coil, and applying the at least one current to the first stator arrangement includes applying a multiphase first current to the first coil and applying a multiphase second current to the second coil, the second current being applied substantially independently from the first current, wherein applying the first current and the second current causes a substantially non-zero net force to be generated.

25. The method of claim 22 wherein the first actuator arrangement includes at least three linear motors, each linear motor of the at least three linear motors being arranged at corners of the stage, each linear motor of the at least three linear motors further being arranged to produce a force in the first horizontal direction and the vertical direction using magnets of the first magnet arrangement and stators of the first stator arrangement.

26. The method of claim 22 wherein the first actuator arrangement includes four pairs of linear motors, each pair of linear motors of the pairs of linear motors being arranged at corners of the stage, each pair of linear motors of the four pairs of linear motors further being arranged to produce a force in the first horizontal direction and a force in the vertical direction using magnets of the first magnet arrangement and stators of the first stator arrangement.

27. The method of claim 22 wherein the stage is a monolithic reticle stage, and wherein the first actuator arrangement and the second actuator arrangement are arranged to cooperate to enable the stage to move in up to six degrees of freedom.

28. The method of claim 22 wherein the stage is arranged to support a plurality of reticles.

29. A stage apparatus comprising:
a stage assembly, the stage assembly including a first magnet arrangement and a second magnet arrangement; and
a first stator arrangement and a second stator arrangement, wherein the first stator arrangement is arranged to cooperate with the first magnet arrangement to allow the stage assembly to control force relative to a first horizontal axis and the second stator arrangement is arranged to cooperate with the second magnet arrangement to allow the stage assembly to control force relative to a vertical axis.

30. The stage apparatus of claim 29 further including:
a countermass, the countermass being arranged to include the first stator arrangement and the second stator arrangement, wherein the countermass is arranged to absorb reaction forces associated with the stage assembly

31. The stage apparatus of claim 30 wherein the stage assembly further includes a third magnet arrangement arranged to cooperate with the countermass to allow the stage assembly to control force relative to a second horizontal axis, the second horizontal axis being substantially perpendicular to the first horizontal axis.

32. The stage apparatus of claim 31 wherein the third magnet arrangement is arranged to cooperate with the countermass to form at least one three-phase linear motor.

33. The stage apparatus of claim 31 wherein the stage assembly is arranged to rotate relative to the first horizontal axis, the second horizontal axis, and the vertical axis.

34. The stage apparatus of claim 29 wherein the first magnet arrangement and the first stator arrangement are arranged as at least one voice coil motor, and wherein the second magnet arrangement and the second stator arrangement are arranged as at least three voice coil motors.

35. The stage apparatus of claim 29 wherein the first magnet arrangement and the second magnet arrangement are each arranged in an approximately U-shaped orientation.

36. The stage apparatus of claim 29 wherein the stage assembly is a monolithic stage assembly.

37. The stage apparatus of claim 29 further including:
a base arrangement; and
an anti-gravity device, the anti-gravity device being arranged to support a weight of the stage assembly relative to the vertical axis, wherein the anti-gravity device is positioned substantially over the base arrangement.

38. The stage apparatus of claim 30 wherein the stage assembly is arranged to support a plurality of reticles.

39. The stage apparatus of claim 30 wherein the stage apparatus is part of an illumination system of an exposure apparatus.

40. A device manufactured with the exposure apparatus of claim 39.

41. A wafer on which an image has been formed by the exposure apparatus of claim 39.

42. The stage apparatus of claim 29 wherein the stage assembly is a non-contact stage.
